(19) United States
(12) Patent Application Publication
(10) Pub. No.: US 2026/0217620 A1
(43) Pub. Date: Jul. 30, 2026

(54) COATING BY CMC CURING FOR HIGH THERMAL PROTECTION

(71) Applicant: PAXIS LTD., Migdal Tefen (IL)

(72) Inventors: Vladislav KUSHNIROV MELNITZER; Itzhak MUTZARY

(21) Appl. No.: 19/147,703

(22) PCT Filed: Jan. 15, 2024
(86) PCT No.: PCT/IB2024/050384

§ 371 Date: Jul. 13, 2025

(30) Foreign Application Priority Data
Jan. 13, 2023 (IL) 299885

(51) Int. Cl. C04B 41/83; C04B 41/45

(52) U.S. Cl. CPC C04B 41/83; C04B 41/4586; C04B 2235/48; C04B 2235/6567; C04B 2235/6581; C04B 2235/96

(57) ABSTRACT

A method for producing a coated ceramic matrix composite (CMC) for high thermal protection includes the steps of (a) forming a CMC comprising at least two plies, and (b) forming a coated CMC by coating the CMC on at least one surface with an impregnated thickening agent, e.g. carbon fiber (CF) cloth, and curing at a predetermined temperature T_{C} for a predetermined time duration t_{C}. The curing is performed in a vacuum or in an inert gas atmosphere and may involve the use of a heated hydraulic press or an autoclave. The CF cloth is impregnated with an organic binder resin matrix. At temperatures exceeding a threshold temperature, free metal, e.g. silicon, migrates to a surface of the coated CMC to form a carbide or boride. Furthermore, a flexural strength of the coated CMC is markedly greater than that of the uncoated CMC by a factor of at least 1.50.

### FIELD OF THE INVENTION

The invention is directed to a method for forming a coated ceramic matrix composite (CMC) for use in high temperature thermal applications.

### BACKGROUND

Silicon carbide (SiC) ceramics are often used as an alternative to metal alloys in aerospace applications such as turbine engine components and thermal protection systems. The flexural strength and thermal conductivity of these ceramics depend on porosity and stoichiometry. On the other hand, oxide (Ox/Ox) ceramics, which are typically used for heat shielding because of their high temperature resistance and very low thermal conductivity, suffer from low compressive and bearing strength.

Some applications require strong lightweight materials and very high thermal protection. For example, air breathing hypersonic vehicles and ballistic vehicles reentering the Earth's atmosphere are often subjected to sustained heat loads at temperatures exceeding the melting point of silicon (T_{S}), which is approximately 1414 degrees Celsius (° C.) at atmospheric pressure, and lower at below atmospheric pressures.

For example, U.S. Pat. No. 5,804,306 to E. T. Sorenson et al., entitled “Ceramic Matrix Composite/Organic Matrix Composite Hybrid Fire Shield”, and dated Sep. 8, 1998, discloses a hybrid fire shield comprised of an organic matrix composite substrate co-bonded with a cured-ceramic matrix composite layer made of a plurality of cured-ceramic matrix composite plies. The CMC layer is intended to be in direct contact with heat and flames. During impingement of the flames and heat, the cured-CMC layer pyrolyzes and converts from a polymeric to a ceramic composite material.

As another example, U.S. Pat. No. 10,562,269 to J. T. Hynes et al., entitled “Polymer Matrix-Ceramic Matrix Hybrid Composites for High Thermal Applications”, and dated Feb. 18, 2020, teaches a composite having a PMC layer, and b) a tile layer comprising a plurality of Ox/Ox CMC ties each having i) a central portion, ii ) an outer portion disposed surrounding the central portion, the bottom surface of the outer portion is disposed flush with the bottom surface of the central portion, the tile layer forms a smooth continuous top surface and a smooth continuous bottom surface, and the tiles are disposed with respect to one another such that each tile is inverted with respect to an adjoining tile, and iii) one or more overlap joints formed by the overlapping of the outer portions of adjoining tiles, so that hot gases entering the smooth top surface of the tile layer between abutting outer and central periphery segments must travel laterally between the overlapping outer portions of adjoining tiles to reach the top of the PMC layer.

### SUMMARY OF THE INVENTION

This application presents a method for producing and testing a coated CMC which provides high thermal protection, as well as high flexural strength.

According to one aspect of the presently disclosed subject matter, there is provided a method for producing a coated CMC for high thermal protection including the steps of (a) forming a CMC including at least two plies, and (b) forming a coated CMC by coating the CMC on at least one side with an impregnated thickening agent and curing at a predetermined temperature T_{C} for a predetermined time duration t_{C}.

According to some aspects, the curing is performed in a vacuum or in an inert gas atmosphere.

According to some aspects, the curing uses a heated hydraulic press or an autoclave.

According to some aspects, the thickening agent is impregnated with an organic binder resin matrix.

According to some aspects, a value of T_{C} is within a range of 180° C. to 220° C.

According to some aspects, a value of t_{C} is within a range of 120 to 150 minutes.

According to some aspects, free metal migrates to a surface of the coated CMC to form a carbide or boride at temperatures exceeding a melting point of the metal.

According to some aspects, the forming of the CMC includes polymer impregnation and/or pyrolysis.

According to some aspects, the polymer impregnation uses an epoxy or phenolic based resin.

According to some aspects, a flexural strength of the coated CMC is greater than that of the uncoated CMC by a factor of at least 1.50.

### BRIEF DESCRIPTION OF THE DRAWINGS

The invention is herein described, by way of example only, with reference to the accompanying drawing.

FIG. 1: An exemplary block diagram of the method of the invention.

### DETAILED DESCRIPTION

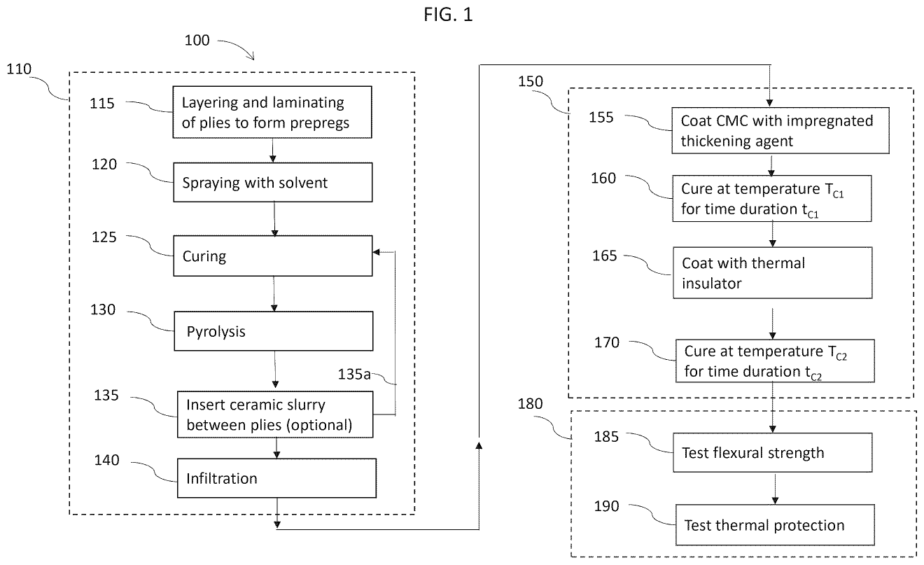

FIG. 1 shows an exemplary block diagram 100 of the method of the invention. Block 110 is an exemplary method for forming a CMC by using polymer impregnation and pyrolysis, commonly known as PIP by those skilled in the art of ceramic manufacturing. PIP processing typically begins with two or more plies of ceramic cloth, either sized or unsized, which are cut to a prescribed geometric pattern, In block 115, the plies are impregnated with polymer resin, e.g. epoxy or phenolic resin and laminated to form prepregs. In block 120, the prepregs are sprayed with a solvent to partially dissolve the resin. The curing in block 125 is carried out by placing the plies in a vacuum bag connected to a vacuum pump. Optionally, the curing may also involve use of a heated hydraulic press or an autoclave. In block 130, the “green state” composite is kept in vacuum or an inert gas atmosphere, e. g nitrogen gas, and heated to a temperature at which all the polymer resin is pyrolyzed. In block 135, the “pyrolyzed state” is kept in vacuum or an inert gas atmosphere and heated to the melting point temperature of the metal, e.g. silicon. The liquid metal infiltrates through capillary action and reacts chemically carbon to form a carbide, e.g. SiC while the polymer resin undergoes complete pyrolysis. At this point in the process, the CMC contains for example carbon, SiC and approximately 10-20% of free silicon.

Blocks 130 and 140—pyrolysis and infiltration, respectively—may be performed in two successive steps as shown FIG. 1, or as a single step. More generally, blocks 130 and 140 may be repeated many times, e.g. ten times, in a typical PIP process. Continued repetition tends to increase the percentage of carbon and SiC, and to reduce the percentage of free silicon (Si) in the CMC.

In some embodiments, there is an optional block 135, in which a ceramic slurry is inserted between the plies. This is generally followed by additional curing and pyrolysis, prior to infiltration, as indicated by the arrow 135a.

When the CMC is in a green state, additional plies may be impregnated and cured using different resins, such as ultra-high temperature ceramic (UHTC) materials based on rare earth elements combined with carbon or boron to form carbides or borides.

Block 150 is an exemplary method for coating the CMC by curing. In block 155, the CMC is coated on at least one surface with a thickening agent. The thickening agent may include a fibrous cloth, fabric or foam typically consisting of carbon or a ceramic such as aluminum oxide (Al₂O₃). The thickening agent is typically impregnated with a resin, such as an organic binder resin.

In block 160, the coated CMC is cured in vacuum or in an inert atmosphere at a first predetermined temperature T_{C1} of typically 180° C. to 220° C., for a first predetermined time duration T_{C1} of typically 120 to 150 minutes. The curing in block 160 curing may also involve use of a heated hydraulic press or an autoclave.

In block 165, a thermally insulating coating, such as a ceramic oxide based slurry is applied. This is followed by block 170, in which the coated CMC is again cured in vacuum or in an inert atmosphere, at a second predetermined temperature T_{C2} and for a second time duration T_{C2}.

Block 180 is an optional block which tests the mechanical and thermal properties of the coated CMC. In block 185, the coated CMC is subjected to a three-point bend test to determine flexural strength. Experiments indicate that the flexural strength at room temperature of the coated CMC is greater than that of the uncoated CMC by a factor of 1.5 to 3.

In block 190, the coated CMC is subjected to a variety of thermal loads to determine its heat resistance. Experiments using an acetylene torch or arc jet, together with imaging at several stages of heating using a scanning electron microscope (SEM), indicate that the thermal protection afforded by the coated CMC is considerably superior to that of the uncoated CMC. For example:
a) When exposed to a temperature of 250° C., the organic matrix begins to degrade. When the temperature reaches 800-1000° C., the organic matrix and the carbon coating undergo complete pyrolysis, making the coating less dense and a better thermal insulator.
b) When the temperature is above 1000° C., but less than the melting point of the free metal (e.g. 1414° C. for Si at atmospheric pressure), the carbon coating begins to degrade but continues to act as an insulator.
c) When the temperature is higher than the melting pint of the free metal, the free metal in the coated CMC migrates to the surface of the coating where it reacts to form a carbide (e.g. SiC), which acts as additional ceramic insulation for the underlying CMC.

It will be appreciated that the above descriptions are intended only to serve as examples, and that many other embodiments are possible within the scope of the present invention as defined in the appended claims.

1. A method for producing a coated CMC for high thermal protection comprising the steps of:
(a) forming a CMC comprising at least two plies, and
(b) forming a coated CMC by coating the CMC on at least one side with an impregnated thickening agent and curing at a predetermined temperature T_{C} for a predetermined time duration t_{C}.

2. The method of claim 1 wherein the curing is performed in a vacuum or in an inert gas atmosphere.

3. The method of claim 1 wherein the curing uses a heated hydraulic press or an autoclave.

4. The method of claim 1 wherein the thickening agent is impregnated with an organic binder resin matrix.

5. The method of claim 1 wherein a value of T_{C} is within a range of 180° C. to 220° C..

6. The method of claim 1 wherein a value of t_{C} is within a range of 120 to 150 minutes.

7. The method of claim 1 wherein free metal migrates to a surface of the coated CMC to form a carbide or boride at temperatures exceeding the melting point of the metal.

8. The method of claim 1 wherein the forming of the CMC comprises polymer impregnation and/or pyrolysis.

9. The method of claim 8 wherein the polymer impregnation uses an epoxy or phenolic based resin.

10. The method of claim 1 wherein a flexural strength of the coated CMC is greater than that of the uncoated CMC by a factor of at least 1.50.
